(19) United States
(12) Patent Application Publication
(10) Pub. No.: US 2002/0110325 A1
(43) Pub. Date: Aug. 15, 2002

(54) Loss compensating optical coupler

(76) Inventors: L. Wayne Sanderson, Fayetteville, TN (US); Jack L. Hayes, Madison, AL (US)

Correspondence Address: LANIER FORD SHAVER & PAYNE, P O BOX 2087, HUNTSVILLE, AL, 35804, US

(21) Appl. No.: 09/784,486

(22) Filed: Feb. 15, 2001

(51) Int. Cl. G02B 6/26; G02B 6/42

(52) U.S. Cl. 385/39

(57) ABSTRACT

An apparatus for compensating for optical loss includes at least two optical fibers joined to form a plurality of ports and first and second coupled regions positioned between the ports. Each coupled region includes a signal transmission region adapted to transmit an optical signal. A semiconductor optical amplifier having an active layer is positioned between the first and second coupled regions such that the active layers is substantially aligned with the signal transmission region to provide a pathway for and amplification to an optical signal passed through the apparatus. A method of compensating for optical loss, a loss compensating optical communication system, and a process of manufacturing an optical signal loss compensating device are also disclosed.

### BACKGROUND OF THE INVENTION

1. Field of the Invention

The present invention relates generally to the field of components for use in optical systems and networks, and more particularly to fiber optic components which divide optical signals among two or more output ports.

While the present invention has a number of uses in the field of fiber optics, it is particularly well suited for compensating for optical signal losses associated with the use of couplers, such as those used to monitor and control data traffic in a fiber optic system or network.

2. Technical Background

In fiber optics, the term, “coupler” generally has a special meaning. A coupler generally connects three or more fiber ends (or optical devices such as detectors and transmitters). It is therefore distinct from connectors and splices which join two fiber ends, or a fiber with a light emitter or detector. This distinction is much more important in fiber optics than in electronics due, in part, to the way signals travel in fibers.

Because optical signals differ from electrical signals, they are transmitted and coupled differently. Unlike an electrical voltage, an optical signal is not a potential, but instead, a flow of signal carriers (photons). Thus, unlike current, an optical signal does not flow through the receiver on its way to ground. Instead, it stops there, and is absorbed by a detector. As a result, multiple fiber-optic receivers cannot be placed in series optically as the first receiver would absorb all of the signal. Accordingly, if an optical signal is to be divided between two or more output ports, the ports must be in parallel. Because the signal is not a potential, the entire signal cannot be delivered to all of the ports, but instead, must be divided between them in some way, reducing its magnitude.

This limits the number of terminals that can be connected in a passive fiber-optic coupler which merely splits up the input signal. After some maximum number of output ports is exceeded, there is generally not enough signal to go around (i.e., to be detected reliably with a low enough bit-error rate or high enough signal-to-noise ratio for the application). This division of power typically limits one transmitter to sending signals to tens of receivers, unless of course, amplifiers or repeaters are used to increase those numbers.

In early fiber-optic systems that carried signals between only pairs of points, fiber-optic couplers were limited in their application. Today, however, many communication applications such as local area networks (LANs) require the connection of many terminals. At each point where a device is connected to the network, the signal must be split into at least two parts—one to be passed along the network, and the other sent to the device. Generally speaking, this may be done in numerous ways. One way is to divide the optical signal at each connection, with part of the signal going to the device, and the rest continuing around the network. This is typically inefficient as coupler losses accumulate around the ring. Another way is to send signals to a central multi-port coupler, which distributes output to all terminals. Couplers are also crucial in Wavelength-Division Multiplexing (WDM) applications. In such applications, couplers are needed to separate or combine signals, usually at different wavelengths, being sent through the same fiber. Light of different wavelengths traveling through the same fiber does not generally interact strongly enough to affect signal transmission. In WDM applications, couplers are used to combine light signals from different sources at the input and separate them at the output.

As mentioned briefly above, most couplers are passive optical devices, which divide signals among two or more output ports. For such passive couplers, the total output power can be no more than the input power. From the viewpoint of each output device, the coupler exhibits a characteristic loss, equal to the ratio (in decibels) of output to that device to total input power. Thus, the equal division of an input signal between two output ports causes a loss of approximately 3 dB. Any additional loss above this theoretical minimum loss is known as excess loss. In the general case of a coupler with one input and many outputs, the total output, summed over all ports, equals input power minus excess loss. Thus, splitting an optical signal among two or more outputs in a passive coupler means that each output has less power than the input. In a perfect coupler, these would be the only losses experienced by the signal, and the sum of the outputs would equal the input. The theoretical perfect coupler, however, does not exist. In traditional couplers, an excess loss is given by taking the ratio of the total output to the input, and is usually given in decibels according to the following equation:

EXCESS LOSS (dB)=−10 log (output power/input power)

In a 1×2 coupler, for example, input power Pᵢₙ is applied to the input fiber and output power P₀₁ and P₀₂ appear at one or both of the output fibers. Accordingly, excess loss (dB) for a 1×2 coupler is defined as −10log((P₀₁+P₀₂)Pᵢₙ). The excess loss is considered power wasted in the coupler.

Another significant source of attenuation resulting from the use of couplers occurs at the connections. At the connections, light is reflected rather than transmitted. The resulting losses associated with these reflections are typically on the order of 0.5 dB or less. These connection losses are in addition to the losses discussed above and contribute further to transmission signal degradation.

As a result of these shortcomings, optical system designers must give due consideration to the number and placement of couplers in system design. Failing to do so may otherwise result in insufficient signal transmission power at the receiving devices in the network. Due to this shortcoming, attempts have been made to compensate for the losses associated with the use of passive optical couplers. These “active devices” serve the same function as couplers, but do, however, generate or amplify light.

Active couplers are essentially special-purpose repeaters that drive both a terminal device and an output fiber. Generally speaking, a receiver detects the input light generating an electronic signal that then passes to decoding electronics. The decoder separates signals intended for that terminal from those intended for the rest of the network and generates two electronic outputs -- one for the terminal device, and the second for an optical transmitter. The transmitter then produces a signal that drives the next fiber segment. This approach is used in some LANs including networks known as Fiber Distributed Data Interface (FDDI) networks. Another approach has been to add an optical amplifier either before, after, or before and after the coupler splits the signal. Amplifiers used in such configurations are intended to make up for lost power to the extent necessary to raise signal strength to meet receiver requirements. Yet another approach has been the introduction of planer waveguide technology into fiber optic systems. The field is often called integrated optics, as it allows many optical devices to be integrated on a single substrate. Losses, however, are extremely high as the substrate material is a poor waveguide. Generally speaking, all of these approaches are expensive to implement and maintain, and the gains intended to compensate for the coupler losses are difficult to control.

What is needed therefore, but currently unavailable in the art, is a fiber optic coupler that can accurately compensate for the theoretical and excess losses that result from an optical signal being divided among two or more output ports. More specifically, there is a need for a loss compensating fiber optic coupler that can efficiently and effectively provide monitoring and control capabilities in a fiber optic network without diminishing the transmission signal strength. In some embodiments, the fiber optic coupler of the present invention should preferably be capable of such compensation over a broad wavelength range, and in some instances have the ability to increase transmission signal strength such that output power exceeds the input power entering the coupler. Such a device should be simple and inexpensive to manufacture, require low power, be easy to maintain, and non-intrusive in operation. It is to the provision of such a device and method that the present invention is primarily directed.

### SUMMARY OF THE INVENTION

One aspect of the present invention relates to an apparatus for compensating for optical loss. The apparatus of the present invention includes a plurality of optical fibers joined to define a plurality of ports and at least one coupled region including a signal transmission region. A semiconductor optical amplifier is positioned between the plurality of ports and includes an active layer having spaced first and second ends constructed and arranged to communicate with the signal transmission region.

Another aspect of the present invention is directed an apparatus for compensating for optical loss. The apparatus of the present invention includes at least two optical fibers joined to form a first coupled region including a first signal transmission region, a second coupled region including a second signal transmission region, and a plurality of ports. A semiconductor optical amplifier is positioned between the first and second coupled regions and includes an active layer substantially aligned with the first and second signal transmission regions to provide a pathway for and amplification to an optical signal passed through the apparatus.

A further aspect of the present invention relates a method of compensating for optical loss. The method of the present invention includes the steps of receiving an optical signal through the input port of an optical coupler which includes a first coupled region, a second coupled region, and a semiconductor optical amplifier having an active layer positioned between the first and second coupled regions. An optical signal is guided through the first coupled region and into the active layer of the semiconductor optical amplifier. The optical signal is amplified as it passes through the active layer of the semiconductor optical amplifier and the amplified signal is collected within the second coupled region as the amplified signal exits the active layer of the semiconductor optical amplifier.

An additional aspect of the present invention is directed to a process of manufacturing an optical signal loss compensating device. The process of the present invention includes the steps of joining at least two optical fibers to form a coupled region in a plurality of ports, dividing the coupled region to form a first member having a first signal transmission region and a second member having a second signal transmission region, and positioning a semiconductor optical amplifier including an active layer between the first and second members.

In a preferred embodiment of the present invention, the process may include the steps of aligning the ends of the active layer with the first and second signal transmission regions so that an optical signal exits the first signal transmission region, passes through the active layer, and enters the second signal transmission region.

A device made by the processes mentioned above is an additional aspect of the present invention.

In yet another aspect of the present invention is directed to a loss compensating optical communication system. The loss compensating optical communication system of the present invention includes a transmitter, a receiver, a transmission line positioned between and cooperating with the transmitter and receiver to carry an optical signal from the transmitter to the receiver, and a loss compensating optical coupler communicating with the transmission line.

The loss compensating optical coupler includes a plurality of optical fibers joined to define a first coupled region, a second coupled region, and a semiconductor optical amplifier positioned between and communicating with the first coupled region and second coupled region. The semiconductor optical amplifier is constructed and arranged to amplify an optical signal passing through the optical coupler.

The loss compensating optical coupler and method of compensating for coupler losses in optical communication systems of the present invention provides a number of advantages over other couplers and methods currently known in the art. For example, the loss compensating optical coupler and method of the present invention allows for non-intrusive monitoring and control of optical transmission signals in a fiber optic network environment. Heretofore, the monitoring and control of optical transmission signals via an optical coupler resulted in a characteristic loss of at least 3 dB. Generally speaking, when optical couplers are used in optical networking environments, coupling losses, fiber losses, splice losses, and connector losses, to name a few, drive the signal loss value much higher. Depending upon system requirements, the minimum characteristic loss alone can adversely affect communications over the network being monitored. Because the loss compensating optical coupler and method of the present invention amplifies the optical transmission signal as it passes through the active layer of the semiconductor optical amplifier of the present invention, the characteristic loss (>3 dB) and other losses associated with the use of couplers may be compensated for before the optical transmission signal leaves the coupler. As a result, the loss compensating optical coupler of the present invention is essentially “invisible” to the fiber optic network in which it is installed.

In addition, the loss compensating optical coupler of the present invention may be manufactured as a single component so that it may be installed and used in a number of different fiber optic networks, often without modification. The amplification source, preferably one or more semiconductor optical amplifiers, associated with the loss compensating optical coupler may be used to provide different amounts of amplification or gain within the coupled region of the loss compensating optical coupler of the present invention. Thus, the same loss compensating optical coupler, for example, may be installed in a fiber optic system requiring compensation for only approximately 3 dB of loss, or it may be installed, for example, in a system requiring compensation for about 3.4 dB of loss. This represents a significant advancement over fiber optic devices and systems presently in service, which attempt to compensate for coupler losses by providing amplification to the system either immediately before or immediately after the coupler. In such systems, different amplification or gain components would likely be installed for the various couplers employed in the network as the amplifier components would likely be specifically designed to meet the system requirements for the various couplers.

Yet another advantage of the loss compensating optical coupler and method of the present invention is realized by fiber optic system designers. Because the losses associated with the couplers of the present invention are compensated for by the couplers themselves, system designers need not include coupler losses in their system calculations when designing a particular optical system or network. As a result, system design is easier, less costly, and less time consuming.

Still another advantage of the loss compensating optical coupler and method of the present invention is the cost savings associated with its use. More specifically, the apparatus used to facilitate amplification in the coupler of the present invention, preferably a semiconductor optical amplifier, is relatively inexpensive to manufacture and use, requires low power, is consistent in operation, and is generally not susceptible to malfunctioning.

A further advantage of the loss compensating optical coupler and method of the present invention relates to flexibility. The loss compensating optical coupler of the present invention may be designed to provide amplification over a broad range of wavelengths. For example, a single loss compensating optical coupler manufactured in accordance with one or more embodiments of the present invention may be capable of amplifying optical signals operating at any wavelength within a wavelength range from about 1280 nm to about 1630 nm. Depending upon, among other things, the choice of fiber material, the number of semiconductor optical amplifiers used in the coupler, and the composition of the semiconductor optical amplifiers used, amplification over other broad wavelength ranges is also possible.

These and additional features and advantages of the invention will be set forth in the detailed description which follows, and in part will be readily apparent to those skilled in the art from that description or recognized by practicing the invention as described herein.

It is to be understood that both the foregoing general description and the following Detailed Description are merely exemplary of the invention and are intended to provide an overview or framework for understanding the nature and character of the invention as it is claimed. The accompanying drawings are included to provide further understanding of the invention and are incorporated in and constitute a part of this specification. The drawings illustrate various embodiments in the invention and together with the description serve to explain the principles and operation of the invention.

### BRIEF DESCRIPTION OF THE DRAWING FIGURES

FIG. 1 schematically depicts a first preferred embodiment of the loss compensating optical coupler in accordance with the present invention.

FIG. 2A-2D schematically illustrate a preferred process for manufacturing an optical signal loss compensating device in accordance with the present invention.

FIG. 3 is a partial cross-sectional view of the coupled region taken along lines 3--3 in FIG. 1 illustrating the positioning and operation of the semiconductor optical amplifier in accordance with the present invention.

FIG. 4 schematically depicts a second preferred embodiment of the loss compensating optical coupler in accordance with the present invention.

FIG. 5 is a partial cross-sectional view of the coupled region taken along lines 5--5 in FIG. 4 illustrating the positioning and operation of a series of semiconductor optical amplifiers in accordance with the present invention.

FIG. 6 is a schematic illustration of a loss compensating optical communication system in accordance with the present invention.

### DETAILED DESCRIPTION OF THE PREFERRED EMBODIMENTS

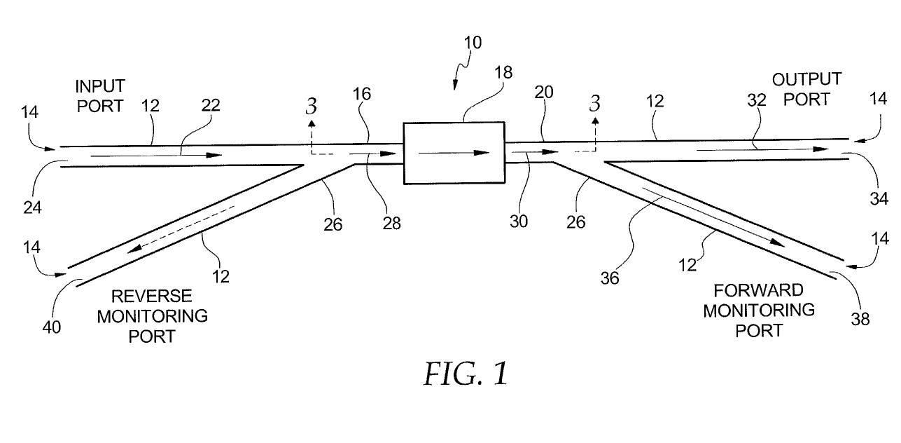

Reference will now be made in detail to the present preferred embodiments of the invention, examples of which are illustrated in the accompanying drawings. Wherever possible, the same reference numerals will be used throughout the drawing figures to refer to the same or like parts. An exemplary embodiment of the loss compensating optical coupler of the present invention is shown schematically in FIG. 1, and is designated generally throughout by reference numeral 10.

In accordance with the invention, the present invention for compensating for optical losses includes a plurality of optical fibers 12 joined to define a plurality of ports 14, at least one coupled region 16, and a semiconductor optical amplifier 18, such as, but not limited to, a semiconductor laser amplifier. Those skilled in the art, however, will recognize that other devices that amplify an optical signal may be used in lieu of semiconductor optical amplifier 18. More preferably, and as shown in the embodiment depicted in FIG. 1, optical coupler 10 also includes a second coupled region 20.

In operation, an optical signal 22 is received through an input port 24 of loss compensating optical coupler 10 and is guided by optical fiber 12 through a tapered region 26 into first coupled region 16. In addition to any optical loss already experienced by optical signal 22, additional loss is incurred when optical signal 22 passes through tapered region 26. Accordingly, a weaker signal 28 travels through coupled region 16 and enters semiconductor optical amplifier 18. As weaker signal 28 passes through semiconductor optical amplifier 18 it is amplified, preferably by stimulated emission. An amplified signal 30 exits semiconductor optical amplifier 18 and is collected within second coupled region 20. Amplified signal 30 is then divided at tapered region 26 such that a transmission signal 32 exits an output port 34 of coupler 10 to continue along the optical network, while a monitoring signal 36 is carried through fiber 12 to a forward monitoring port 38.

Generally speaking, semiconductor optical amplifier 18 of loss compensating optical coupler 10 of the present invention at least compensates for the loss experienced by optical signal 22. As a result, the light waves of optical signal 22 will at least have substantially the same power when they exit semiconductor optical amplifier 18 as they did when they entered semiconductor optical amplifier 18. Accordingly, the light waves of optical signal 22 exiting through output port 34 will re-enter the transmission line (not shown) with substantially the same power and at substantially the same wavelength as they had when they entered input port 24. The loss typically associated with the light waves exiting through forward monitoring port 38 and reverse monitoring port 40 is thus essentially compensated for. More preferably, loss compensating optical coupler 10 may provide sufficient amplification to provide optical signal gain in excess of the loss experienced by optical signal 22. In such case, transmission signal 32 will exit output port 34 and re-enter the transmission line (not shown) with more power than optical signal 22 had when it entered input port 24. Such a loss compensating optical coupler 10 may also at least partially compensate for other losses not associated with the use of the coupler itself, such as, but not limited to, the loss in transferring light from the transmission source into the fiber, connector losses, splice losses, fiber losses, and fiber-to-receiver coupling losses, to name a few.

Transmission and monitoring fibers 12 of the present invention may be made of glass, plastic, plastic clad glass, or other specialty materials, such as, but not limited to, zirconium based fluoride and indium-based fluoride compounds, and tellurite-based compounds. Generally speaking, preferred transmission and monitoring fibers 12 are silica (Sio₂) based glass fibers which may be doped with germania (GeO₂) or some other suitable material(s). While the present invention may be implemented more efficiently with single mode optical fiber, it is operative with multi-mode optical fiber as well. Further, while standard single mode fiber is generally manufactured to have a total diameter of 125 μm and a core diameter ranging from about 9 μm to 11 μm, fibers having other diameters may be used, provided they can be adequately coupled, in accordance with the present invention without exhibiting excessive loss.

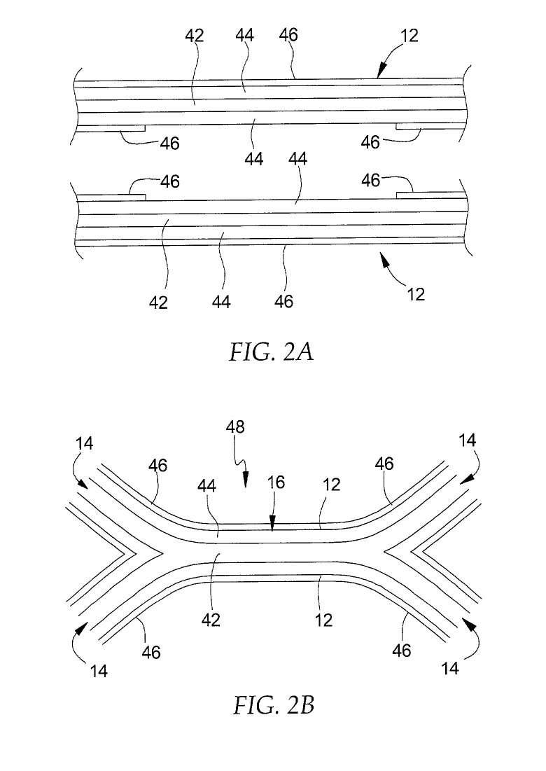

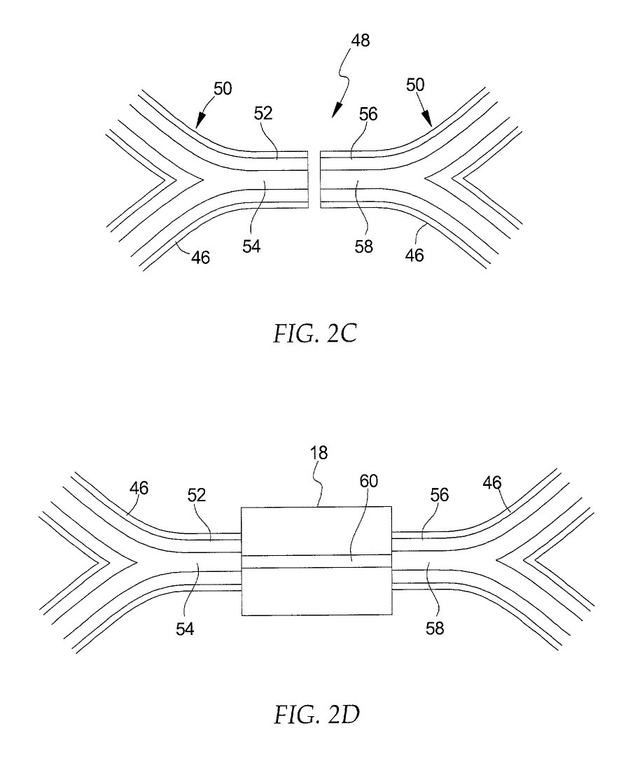

FIGS. 2A through 2D depict a preferred process for manufacturing an optical signal loss compensating device in accordance with the present invention. As shown in FIG. 2A, at least two optical fibers 12, each having a core region 42, a cladding region 44, and a protective sheath 46 (typically a plastic material) are positioned adjacent one another. A portion of protective sheath 46 is preferably removed from each optical fiber 12 to facilitate formation of a coupled region 16 (FIG. 2B). As shown in FIG. 2B, optical fibers 12 are then preferably brought together where the sheath 46 has been removed and are melted or fused via a heat source (not shown) to form a coupled region 16 and a plurality of ports 14. More preferably, prior to fusing, some or all of the cladding region 44 is removed from that area of each fiber 12 where protective sheath 46 has been removed. In addition, fibers 12 are preferably pulled during the fusing step to create a tapered region where light can be transferred between the substantially joined core regions 42.

The resulting optical coupler 48 is then cut or spliced as shown in FIG. 2C to form two separate two-port to one-port transition couplers 50. Each transition coupler 50 preferably includes a first coupled member 52 having a first signal transmission region 54 and a second coupled member 56 having a second signal transmission region 58. As shown in FIG. 2D, semiconductor optical amplifier 18 having an active layer 60 is positioned between the first coupled member 52 and second coupled member 56. In a preferred embodiment, semiconductor optical amplifier 18 is bonded to the cut ends of first coupled member 52 and second coupled member 56 such that active layer 60 is substantially aligned with first signal transmission region 54 and second signal transmission region 58.

As will be described in greater detail below, the ends of semiconductor optical amplifier 18 are preferably coated with an anti-reflective coating material prior to being bonded to coupled members 52 and 56. Moreover, one or more additional semiconductor optical amplifiers 18 may be positioned between coupled members 52 and 56. In such an embodiment, the multiple semiconductor optical amplifiers 18 are preferably aligned and bonded end to end in series such that each active layer 60 is substantially aligned with the active layer 60 of adjacent semiconductor optical amplifiers 18.

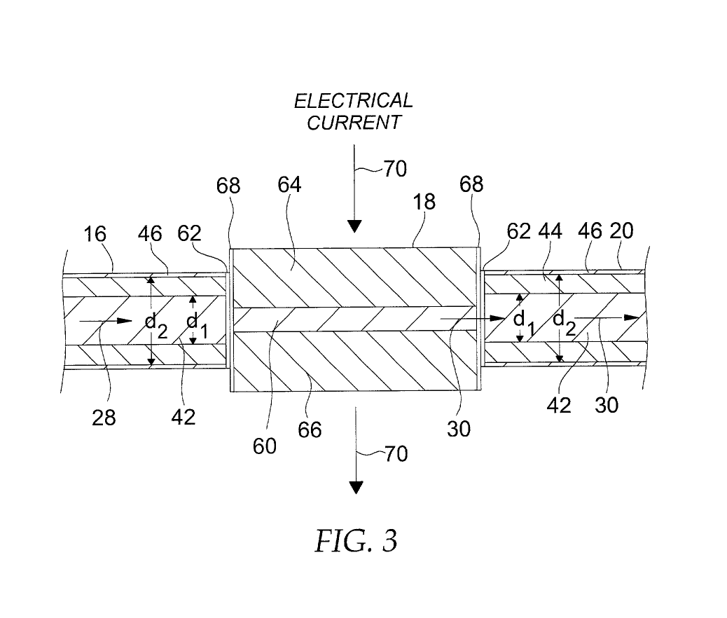

As shown more clearly in the partial cross-sectional view depicted in FIG. 3, a preferred embodiment of loss compensating optical coupler 10 of the present invention preferably includes a coupled region 16, and a coupled region 20 each of which includes a core-clad optical fiber span having an axially extending central core region 42 bounded by a clad region 44 which has a lower index of refraction than that of core region 42. Like the other fibers 12 discussed above, the refractive index of the core regions 42 is higher than that of the cladding regions 44 so that light passing through core regions 42 will be substantially confined within core regions 42 by a phenomenon known in the art as total internal reflection. Those of skill in the art will recognize, however, that at least some light will be lost, causing attenuation of the signal when, among other things, the optical signals are carried over long distances.

Each coupled region 16 and 20 includes a core diameter d₁ and a total (core-clad) diameter d₂. In addition, coupled regions 16 and 20 are preferably formed from SiO₂ based optical waveguides having core regions 42 which may be doped with a light amplifying material or materials such as one or more rare earth elements.

As will be readily apparent to those skilled in the art, coupled regions 16 and 20 may be coated with one or more protective sheaths 46 which are generally applied to increase total diameter d₂ to 125 μm (or some other standard size), and to increase the fiber strength and durability. Often, protective sheath 46 is a plastic material, or in certain applications a titanium containing material. It will also be understood by those skilled in the art, that optical fibers 12, including coupled regions 16 and 20 may be manufactured using any of a number of the chemical vapor deposition (CVD) techniques, plasma techniques, or other optical fiber manufacturing techniques known in the art.

The operation of loss compensating optical coupler 10 of the present invention may also be more clearly understood with reference to the partial cross-sectional view of coupled regions 16 and 20 depicted in FIG. 3. FIG. 3 illustrates the preferred positioning of semiconductor optical amplifier 18 with respect to core region 42 and clad region 44. Semiconductor optical amplifier 18 is preferably positioned between coupled region 16 and second coupled region 20 such that core regions 42 are substantially aligned with active layer 60 of semiconductor optical amplifier 18. The ends of semiconductor optical amplifier 18 are then preferably adhered adjacent core region 42 with an adhesive such as an epoxy 62 which is substantially transparent to light delivered through coupled regions 16, 20 at the pumping wavelengths, or by techniques such as ultra-violet (UV) heating. When an index-matching material such as a transparent epoxy is used, a transparent gel or solid having a refractive index close to that of the core regions 42 is preferred.

Semiconductor optical amplifier 18 such as, but not limited to, a semiconductor diode laser preferably includes at least two substrate materials 64 and 66 with an active layer 60 positioned therebetween. Unlike traditional laser sources which have reflective ends to keep light bouncing back and forth within active layer 60, semiconductor optical amplifier 18 is preferably coated at its ends with anti-reflective coatings 68. While a semiconductor optical amplifier 18 having an active layer 60 only a few micrometers across and a fraction of a micrometer high is operative with the present invention, it is preferable that active layer 60 is matched as closely as possible to the size and shape of core regions 42 of coupled region 16 and 20. Such size matching limits the loss of light, and thus optical signal, otherwise resulting from beam spreading or divergence. Although semiconductor optical amplifier 18 is a preferred source of amplification for active coupler 10, it is to be understood that other amplification sources such as other diode lasers, as well as other amplifying devices may be employed in accordance with other embodiments of the present invention.

The primary compositions used in diode laser light sources, and thus semiconductor optical amplifier 18 are variations on the standard III-V semiconductor compounds that can be fabricated on substrates of gallium arsenide or indium phosphide. Generally speaking, Ga₍₁₋ₓ₎AlₓAS on GaAs is a preferred material for operation in the 780 nm to 850 nm wavelength range, IN_{0.73}GA_{0.27}AS_{0.58} P_{0.42} on InP is a preferred material for operation at the 1310 nm window, and In_{0.58}GA_{0.42}As_{0.9}Po_{0.1} on InP is a preferred material for operation in the 1550 nm window. Other InGaAsP mixtures may be used for other wavelengths between about 1100 nm and 1600 nm. As those skilled in the art will recognize, the need for the proper band-gap in the active layer and for interatomic spacings reasonably close to those of readily available substrates (a restriction that has been relaxed recently in the development of strained-layer structures) are important design considerations. As mentioned previously and as depicted in FIG. 3, because the ends of semiconductor optical amplifier 18 are coated to suppress reflection of light back into semiconductor optical amplifier 18, weakened optical signal 28 is directed into active layer 60, where stimulated emission amplifies it. Amplified signal 30 then emerges from the opposite end of semiconductor optical amplifier 18 where it is collected in core region 42 of second coupled region 20. Ideally, none of the signal light is reflected back into semiconductor optical amplifier 18. Provided core region 42 of second coupled region 20 is sized to substantially match the size of the active layer 60, transfer losses will be minimal.

In operation, and as illustrated in FIG. 3, an optical signal enters coupled region 16 of loss compensating optical coupler 10 as a weakened optical signal 28, due in part to the various coupling losses. An electrical current 70 is set running through semiconductor optical amplifier 18 in order to excite electrons which can then fall back to the non-excited ground state and thus give out photons (particles of light). The light is emitted when something (e.g. an electron in a semiconductor) drops from a higher energy level to a lower one, releasing the extra energy. Generally speaking, the electrons remain at a high energy level until the requisite amount of energy needed for emission is introduced. In this case, photons from weaker signal 28 have the requisite energy to stimulate the electron in the upper energy level to drop to the lower one, thus emitting its energy as light of the same wavelength. The result is a second identical photon, and the process is generally known in the art as stimulated emission. Thus, as weaker signal 28 is directed onto active layer 60, stimulated emission occurs as weaker signal 28 passes through active layer 60. The addition of photons results in an amplified signal 30 exiting the opposite end of semiconductor optical amplifier 18. Amplified signal 30 is then collected within core region 42 of coupled region 20.

Amplification preferably occurs as the optical signal makes a single pass through active layer 60, thus compensating for the transmission signal 22 coupling losses and other losses. When amplified transmission signal 32 exits output port 34 of loss compensating optical coupler 10, the signal strength is substantially identical to, and may be stronger than optical signal 22 prior to its entry into input port 24 of loss compensating optical coupler 10. When the composition of active layer 60 is InGaAsP, gains of approximately 25 dB to 30 dB may be realized at an operating wavelength of approximately 1310 nm-1550 nm. Moreover, output powers may exceed 10 dBm.

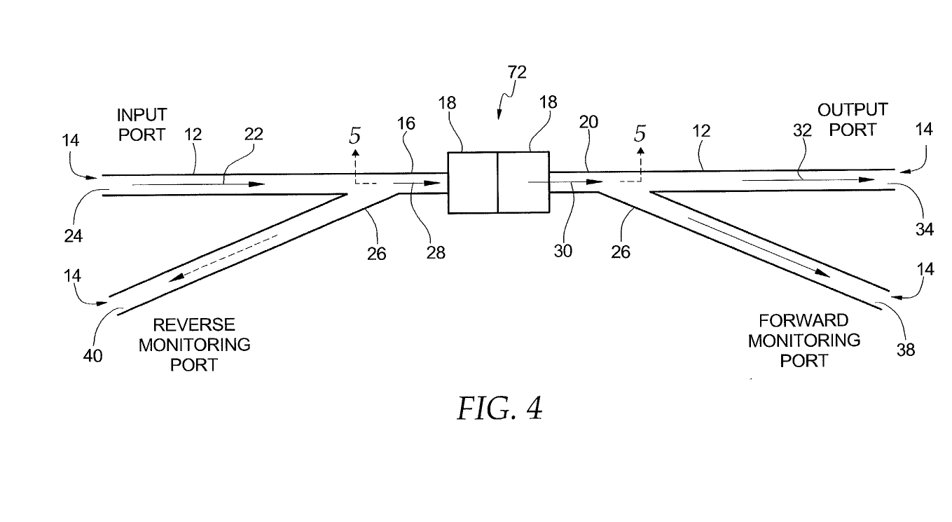

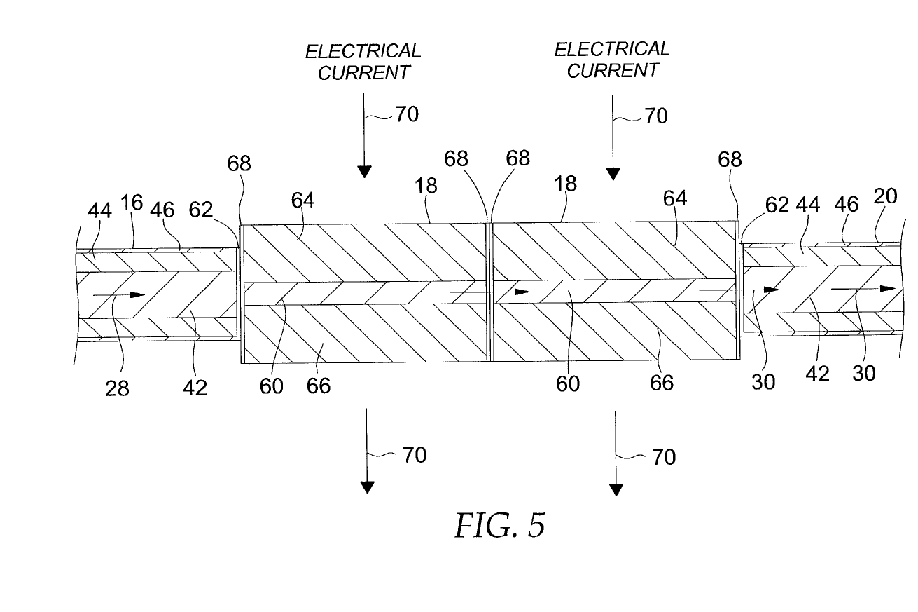

FIGS. 4 and 5 depict a second preferred embodiment of loss compensating optical coupler 72 of the present invention. Loss compensating optical coupler 72 is substantially identical to loss compensating optical coupler 10 of the present invention with the exception that loss compensating optical coupler 72 includes a pair of semiconductor optical amplifiers 18, such as semiconductor diode lasers, preferably aligned end to end in series between coupled regions 16 and 20. Loss compensating optical coupler 72 is preferably formed by “fusing” two optical fibers, one or both of which may be pre-doped with erbium or some other rare earth element(s). Optical fibers 12 are preferably heated and drawn so that core regions 42 of each optical fiber 12 essentially combine into a single core. It will be understood by those skilled in the art, however, that optical fibers 12 may be coupled using other conventional methods known in the art, such as core-to-core splicing. Once fused, loss compensating optical coupler 72 preferably defines a plurality of ports 14 and a coupled region 16. Coupled region 16 is then cut or spliced to form a first coupled region 16 and a second coupled region 20 between which are positioned a pair of semiconductor optical amplifiers 18, preferably in series. The additional semiconductor optical amplifier 18 provides additional amplification or gain to weaker signal 28 directed into lead semiconductor optical amplifier 18 by first coupled region 16. As a result, weaker optical transmission signal 28 may pass into active layer 60 of the first or lead semiconductor optical amplifier 18 where it is amplified by stimulated emission, continue through active layer 60 of second semiconductor optical amplifier 18 where it is further amplified by stimulated emission, and thereafter exit active layer 60 of second semiconductor optical amplifier 18 as amplified transmission signal 30, which is substantially collected in core region 42 of second coupled region 20.

Loss compensating optical coupler 72 can effectively compensate for characteristic coupler losses and other losses associated with signal splitting through forward monitoring port 38 and reverse monitoring port 40. As a result, forward monitoring port 38 and reverse monitoring port 40 may be effectively used to monitor optical transmission signals 22 and 32 and provide appropriate system control as a result of that monitoring without adversely affecting optical signal strength. When semiconductor optical amplifiers 18 are formed from the proper compositions, loss compensating optical coupler 72 provides the desired compensation for losses over the usable wavelengths near the 1540 nanometer window. The amount of loss compensation may be controlled by altering semiconductor optical amplifier 18 composition as described above, and by increasing or decreasing the number of semiconductor optical amplifiers.

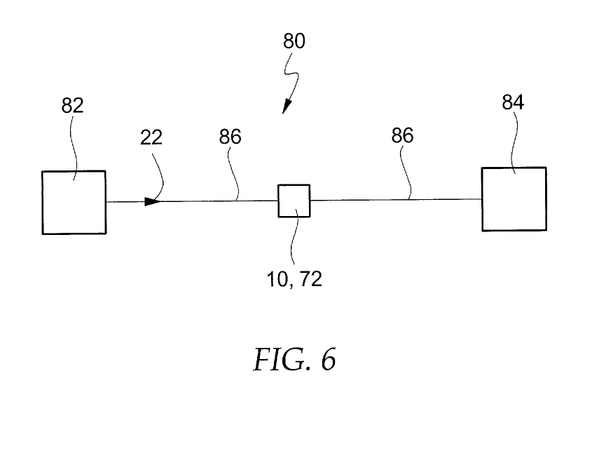

FIG. 6 illustrates a loss compensating optical communication system 80 in accordance with the present invention. System 80 preferably includes at least a transmitter 82 for generating an optical transmission signal 22, a receiver 84 remote from transmitter 82 for receiving and interpreting the transmitted optical transmission signal 22, a transmission line 86 such as long haul optical fiber positioned between and cooperating with the transmitter 82 and receiver 84 to carry optical transmission signal 22 from the transmitter 82 to the receiver 84, and at least one loss compensating optical coupler 10, 72 communicating with the transmission line 86. When system 80 is a long haul fiber network, the network will typically incorporate other components such as amplifiers, repeaters, wavelength division multiplexers (WDMs) and demultiplexers, optical isolators, and other optical components.

It will be apparent to those skilled in the art that various modifications and variations can be made to the present invention without departing from the spirit and scope of the invention. For example, although the present invention has been shown and described with reference to a 2×2 coupler, the present invention is equally applicable to 1×2 couplers, splitters, and the like. Thus it is intended that the present invention cover the modifications and variations of this invention provided they come within the scope of the appended claims and their equivalents.

What is claimed is:

1. An apparatus for compensating for optical loss, said apparatus comprising:
a plurality of optical fibers joined to define a plurality of ports and at least one coupled region including a signal transmission region; and
a semiconductor optical amplifier positioned between said plurality of ports, said semiconductor optical amplifier including an active layer having spaced first and second ends constructed and arranged to communicate with the signal transmission region.

2. The apparatus of claim 1 wherein said semiconductor optical amplifier comprises a plurality of semiconductor optical amplifiers.

3. The apparatus of claim 1 wherein the ends of said semiconductor optical amplifier are coated with an anti-reflective coating and bonded to the at least one coupled region such that the active layer of said semiconductor optical amplifier is substantially aligned with the signal transmission region.

4. The apparatus of claim 1 wherein said semiconductor optical amplifier at least compensates for optical signal loss when an electrical current is set running through said semiconductor optical amplifier as an optical signal passes therethrough.

5. An apparatus for compensating for optical loss, said apparatus comprising:
at least two optical fibers joined to form a first coupled region including a first signal transmission region, a second coupled region including a second signal transmission region, and a plurality of ports; and
a semiconductor optical amplifier positioned between the first and second coupled regions, said semiconductor optical amplifier including an active layer substantially aligned with the first and second signal transmission regions to provide a pathway for and amplification to an optical signal passed through said apparatus.

6. The apparatus of claim 5 wherein said first coupled region and said second coupled region are positioned between said plurality of ports.

7. The apparatus of claim 5 wherein said semiconductor optical amplifier comprises a plurality of semiconductor optical amplifiers.

8. The apparatus of claim 5 wherein the ends of said semiconductor optical amplifier are coated with anti-reflective coatings, and wherein one end is bonded to the first coupled region and the other end is bonded to the second coupled region.

9. The apparatus of claim 5 wherein said semiconductor optical amplifier comprises, Ga₍₁₋ₓ₎AlₓAS on a substrate material selected from the group consisting of GaAs or InP.

10. A method of compensating for optical loss, said method comprising the steps of:
receiving an optical signal through the input port of an optical coupler, said optical coupler comprising a first coupled region, a second coupled region and a semiconductor optical amplifier including an active layer positioned between the first and second coupled regions;
guiding the optical signal through said first coupled region and into the active layer of said semiconductor optical amplifier;
amplifying the optical signal as it passes through the active layer of said semiconductor optical amplifier; and
collecting the amplified signal within said second coupled region as the amplified signal exits the active layer of said semiconductor optical amplifier.

11. The method of claim 10 wherein said amplifying step comprises the step of passing a current through said semiconductor optical amplifier as the optical signal passes through the active layer.

12. The method of claim 10 further comprising the step of monitoring the optical signal via a monitoring port.

13. A process of manufacturing an optical signal loss compensating device, said process comprising the steps of:
joining at least two optical fibers to form a coupled region and a plurality of ports;
dividing the coupled region to form a first member having a first signal transmission region and a second member having a second signal transmission region; and
positioning a semiconductor optical amplifier between the first and second members, said semiconductor optical amplifier including an active layer.

14. The method of claim 13 further comprising the step of aligning the ends of the active layer with the first and second signal transmission regions so that an optical signal can exit the first signal transmission region, pass through the active layer and enter the second signal transmission region.

15. The process of claim 14 further comprising the step of fixing the position of said semiconductor optical amplifier with respect to the fist and second signal transmission regions.

16. A device made by the process of claim 13.

17. The process of claim 13 further comprising the step of coating the ends of said semiconductor optical amplifier with an anti-reflective coating.

18. The process of claim 17 further comprising the step of bonding the ends of said semiconductor optical amplifier to the first and second members following said coating step.

19. A loss compensating optical communication system comprising:
a transmitter;
a receiver;
a transmission line positioned between and cooperating with said transmitter and said receiver to carry an optical signal from said transmitter to said receiver; and
a loss compensating optical coupler communicating with said transmission line and comprising a plurality of optical fibers joined to define a first coupled region, a second coupled region, and a semiconductor optical amplifier positioned between and communicating with the first coupled region and the second coupled region, said semiconductor optical amplifier constructed and arranged to amplify the optical signal passing through said optical coupler.
